(19) United States
(12) Patent Application Publication
(10) Pub. No.: US 2026/0030446 A1
(43) Pub. Date: Jan. 29, 2026

(54) SEGMENTING TEXT USING MACHINE LEARNING MODELS

(71) Applicant: X Development LLC, Mountain View, CA (US)

(72) Inventors: Klara Kaleb, London (GB); Huihui Xu, Pittsburgh, PA (US); Garrett Raymond Honke, Mountain View, CA (US); Jeffrey Bush, Los Altos, CA (US); Irhum Shafkat, San Francisco, CA (US)

(21) Appl. No.: 18/785,645

(22) Filed: Jul. 26, 2024

(51) Int. Cl. G06F 40/205; G06F 16/33; G06F 40/284; G06F 40/289

(52) U.S. Cl. CPC G06F 40/205; G06F 16/3331; G06F 40/284; G06F 40/289

(57) ABSTRACT

Methods, systems, and apparatus, including computer programs encoded on computer storage media, for determining segments from a sequence of text. One of the methods includes obtaining data representing a sequence of text; dividing the sequence of text into a plurality of sentence fragments; determining split scores comprising determining a split score for each of a plurality of pairs of sentence fragments formed from the plurality of sentence fragments; assigning one or more split positions based on the split scores; and combining the plurality of sentence fragments back into at least two segments, with a boundary of at least one of the at least two segments being identified by one of the one or more split positions, and wherein each segment comprises one or more sentence fragments.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers to generate an output for a received input. For example, a deep neural network is a deep machine learning model that includes an output layer and one or more hidden layers that each apply a non-linear transformation to a received input to generate an output.

### SUMMARY

This specification describes a system implemented as computer programs on one or more computers in one or more locations for determining segments from a given sequence of text. For example, the system can determine segments in the sequence of text using one or more machine learning models.

In general, one innovative aspect of the subject matter described in this specification can be embodied in methods that include the actions of obtaining data representing a sequence of text; dividing the sequence of text into a plurality of sentence fragments; determining split scores comprising determining a split score for each of a plurality of pairs of sentence fragments formed from the plurality of sentence fragments; assigning one or more split positions based on the split scores; and combining the plurality of sentence fragments back into at least two segments, with a boundary of at least one of the at least two segments being identified by one of the one or more split positions, and wherein each segment comprises one or more sentence fragments.

Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The foregoing and other embodiments can each optionally include one or more of the following features, alone or in combination. In particular, one embodiment includes all the following features in combination.

In some implementations, the sequence of text represents one or more legal documents.

In some implementations, obtaining data representing a sequence of text comprises receiving the data from a user.

In some implementations, the method further comprises providing the at least two segments to a user.

In some implementations, the method further comprises: receiving a query from a user; identifying one or more relevant segments to the query from the at least two segments; and providing the one or more identified relevant segments to the user.

In some implementations, dividing the text into a plurality of sentence fragments comprises providing the sequence of text as input to a model that is configured to generate a plurality of sentence fragments given an input sequence of text.

In some implementations, determining a split score for each of a plurality of pairs of sentence fragments comprises: generating a corresponding embedded sentence fragment for each of the plurality of sentence fragments; for each pair of sentence fragments: determining a first similarity score between two sentence fragments in the pair of sentence fragments; determining one or more second similarity scores, wherein each second similarity score is determined between two sentence fragments in the plurality of sentence fragments; and determining the split score for the pair of sentence fragments by combining the first similarity score and the one or more second similarity scores.

In some implementations, determining a first similarity score comprises computing a similarity between the corresponding embedded sentence fragments for the two sentence fragments.

In some implementations, determining one or more second similarity scores comprises, for each of the one or more second similarity scores: computing a similarity between a first embedded sentence fragment and a second embedded sentence fragment, wherein the first embedded sentence fragment comprises the corresponding embedded sentence fragment for a first particular sentence fragment of the two sentence fragments, and wherein the second embedded sentence fragment comprises the corresponding embedded sentence fragment for a second particular sentence fragment of the plurality of sentence fragments.

In some implementations, determining a first similarity score comprises providing the corresponding embedded sentence fragments for the two sentence fragments to a machine learning model that is configured to generate a similarity score between vectors.

In some implementations, determining one or more second similarity scores comprises, for each of the one or more second similarity scores: providing a first embedded sentence fragment and a second embedded sentence fragment to a machine learning model that is configured to generate a similarity score between vectors, wherein the first embedded sentence fragment comprises the corresponding embedded sentence fragment for a first particular sentence fragment of the two sentence fragments, and wherein the second embedded sentence fragment comprises the corresponding embedded sentence fragment for a second particular sentence fragment of the plurality of sentence fragments.

In some implementations, combining the first similarity score and the one or more second similarity scores comprises computing a weighted sum of the first similarity score and the one or more second similarity scores.

In some implementations, determining a split score for each of a plurality of pairs of sentence fragments comprises using a language model to identify whether two sentence fragments are similar in the pair of sentence fragments.

In some implementations, assigning one or more split positions based on the split scores comprises determining one or more split positions that each reflect a lowest similarity between two sentence fragments in a particular pair of sentence fragments among the plurality of pairs of sentence fragments.

In some implementations, the one or more split positions that each reflect a lowest similarity between two sentence fragments have a highest split score among the plurality of pairs of sentence fragments.

In some implementations, assigning one or more split positions based on the split scores comprises assigning one or more split positions based on a current set of split scores at each of a plurality of iterations, and wherein the method comprises, at each iteration: determining that a termination condition has not been met; in response to determining that the termination condition has not been met, assigning a split position corresponding to an index for a pair of sentence fragments with a highest split score in the current set of split scores; modifying the current set of split scores by setting the highest split score to zero; identifying a first set of sentence fragments comprising one or more sentence fragments of the plurality of sentence fragments preceding the split position; identifying a second set of sentence fragments comprising one or more sentence fragments of the plurality of sentence fragments following the split position; for each set of the first set and second set: identifying a respective subset of sentence fragments in the set; modifying the current set of split scores by setting one or more of the split scores for the pairs of sentence fragments in the respective subset to zero; and updating the current set of split scores to the split scores for the sentence fragments of the set.

In some implementations, the respective subset of sentence fragments comprises a cumulative number of tokens greater than or equal to a threshold number of tokens.

In some implementations, the termination condition is defined by a condition where all of the split scores are zero.

Particular embodiments of the subject matter described in this specification can be implemented to realize one or more of the following advantages.

Machine learning models such as large language models can perform a variety of tasks with input text. However, large language models have a finite context window (e.g., hundreds or thousands of tokens) and can process a limited amount of text at a time, and may require that a long sequence of text be split into segments for processing. Conventional systems for separating text may separate text into segments based on rules that result in segments that are not semantically meaningful. Providing these segments as input to a large language model may lead to suboptimal processing results. Furthermore, a sequence of text that fits within the context window may include multiple topics. Providing the entire sequence of text as input to a large language model may also lead to suboptimal processing results. The system described in this specification can automate the identification and separation of text into semantically meaningful segments for processing by downstream processing systems such as large language models.

Conventional systems for separating text may separate text into segments that are not semantically meaningful. For example, conventional systems may split text into segments of fixed token length such as a fixed number of characters, subwords, or words. These segments may include sentences or ideas that have been cut off. These segments may also include text relating to more than one topic. Some conventional systems may split text based on particular characters such as punctuation or newline characters. For example, splitting based on punctuation may result in text relating to one topic being separated among multiple segments. As another example, splitting on punctuation may result in unintelligible segments, particularly for citations such as legal citations. Splitting on newline characters may result in long segments that include multiple topics, or that require further splitting for downstream processing.

In some examples, the given sequence of text can be a document with document tags. Conventional systems may identify each child node as a segment. However, these systems are limited to documents with document tags, and tagging the documents can be time-consuming. In addition, each of these segments may not include enough information for downstream processing.

The system can identify and generate segments or sections of a document, where each segment or section is self-contained. That is, each segment includes semantically relevant content, or content that relates to the same topic. For example, the system can divide the given sequence of text into sentence fragments and determine split scores for each pair of sentence fragments. The system can assign split positions based on the split scores. The system can then combine the sentence fragments into segments whose boundaries are defined by the split positions. Providing semantically relevant and self-contained segments as input to a large language model can lead to improved processing results over providing a sequence of text that includes multiple topics as input to the large language model. For example, the large language model can generate an output for a similarity-based retrieval task that is more useful when processing a semantically relevant and self-contained segment compared to the output when processing a sequence of text with multiple topics.

In addition, the system can automate the identification and generation of self-contained segments of a document. For example, by assigning split positions based on split scores, the system can identify and generate self-contained segments for large documents, and for large numbers of large documents. The system can also identify and generate self-contained segments consistently.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example system for determining segments of text.

FIG. 2 is a flow diagram of an example process for determining segments of text.

FIG. 3 is a flow chart of an example process for determining segments of text.

FIG. 4 is a flow chart of an example process for determining split scores.

FIG. 5 is a flow chart of an example process for assigning split positions.

FIG. 6 depicts a schematic diagram of a computer system that may be applied to any of the computer-implemented methods and other techniques described herein.

Like reference numbers and designations in the various drawings indicate like elements.

### DETAILED DESCRIPTION

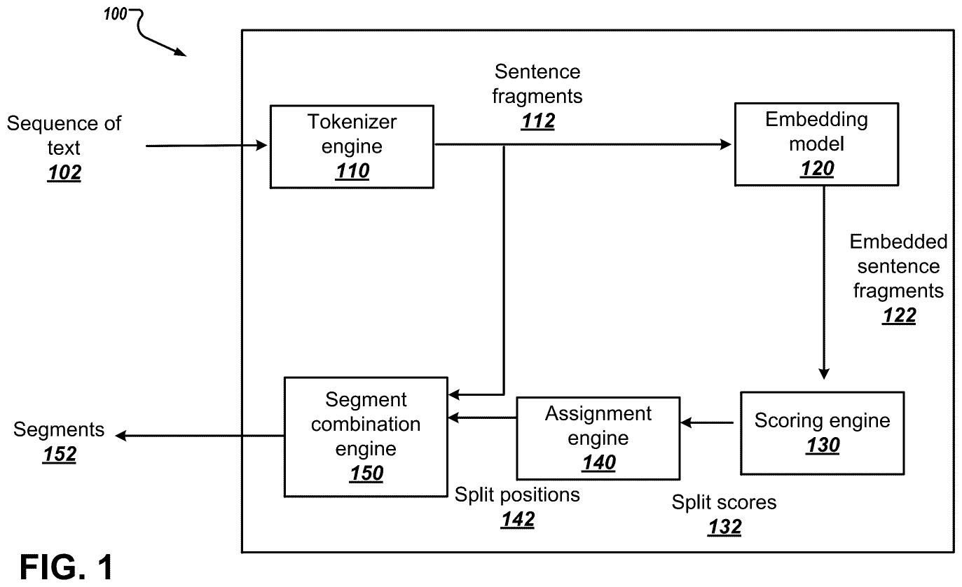

FIG. 1 shows an example system 100 for determining segments of text. The system 100 is an example of a system implemented as computer programs on one or more computers in one or more locations. The system 100 can include a tokenizer engine 110, an embedding model 120, a scoring engine 130, an assignment engine 140, and a segment combination engine 150. In some implementations, the components can be part of a same system and/or network of computing devices and/or systems.

The tokenizer engine 110 can be any appropriate computing system that is configured to divide a given sequence of text into sentence fragments. Each sentence fragment can include at least part of a sentence. For example, the tokenizer engine 110 can generate sentence fragments 112 from the sequence of text 102. As an example, the tokenizer engine 110 can be a T5 tokenizer, a spaCy tokenizer, or an NLTK tokenizer.

The sequence of text 102 can include one or more documents. For example, the one or more documents can include legal documents such as contracts, court cases, and/or court transcripts. Although this specification can be applied to sequences of text that include legal documents, the system 100 can be used to generate segments for many types of sequences of text such as general business documents.

The embedding model 120 can be any appropriate computing system that is configured to generate embeddings of data such as text. For example, the embedding model 120 can generate embeddings of the sentence fragments 112. An “embedding,” as used in this specification is a vector of numeric values, e.g., floating point or other type of numeric values, that has a predetermined dimensionality, e.g., has a predetermined number of values. In some implementations, the embedding model 120 can be finetuned on training data for a particular domain, such as the legal domain.

As an example, the embeddings can be generated from the activations of one of the dense layers of the embedding model 120. For example, the embeddings can be the activations of the last dense layer or an intermediate layer of the embedding model 120. As another example, the embedding model 120 can include dense layers similar to dense layers of a language model neural network, without the softmax and logit layers of the language model neural network.

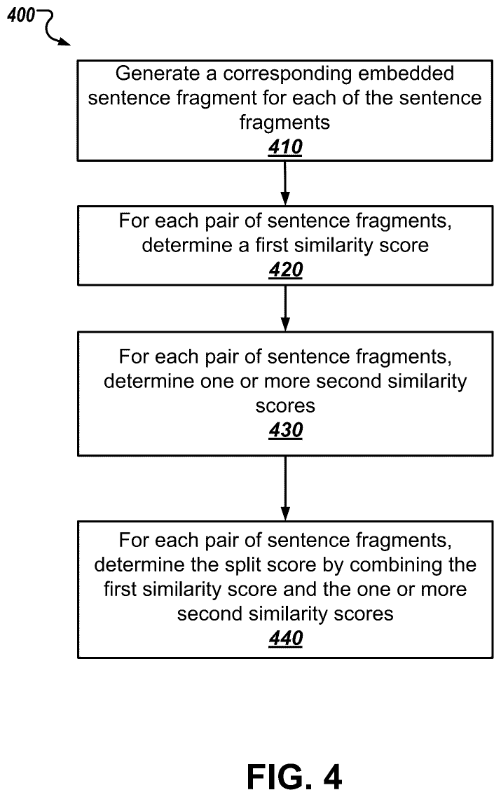

The scoring engine 130 can be any appropriate computing system that is configured to generate similarity scores and split scores. Each split score can correspond to a pair of consecutive sentence fragments and can represent a likelihood that the pair of sentence fragments belong to different segments. Each split score can have a corresponding identifier, for example, that identifies the corresponding pair of sentence fragments. For example, the scoring engine 130 can generate split scores 132 for the sentence fragments 112 by processing the corresponding embedded sentence fragments 122 to determine similarity scores. The scoring engine 130 can generate split scores 132 in any of a variety of ways, as described below with reference to FIG. 4.

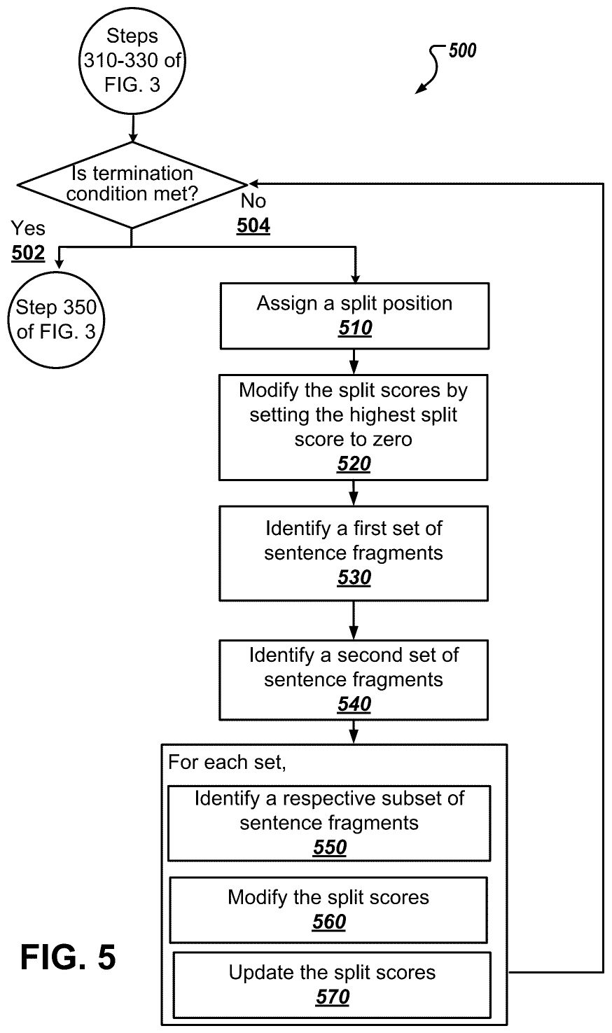

The assignment engine 140 can be any appropriate computing system that is configured to assign split positions based on split scores. Each split position can correspond to a split score and can represent that the sentence fragments that correspond to the split score should belong to different segments. For example, the assignment engine 140 can identify split positions 142 based on the split scores 132. Assigning split positions based on split scores is described in more detail below with reference to FIG. 5.

The segment combination engine 150 can be any appropriate computing system that is configured to determine segments given sentence fragments and split positions. For example, the segment combination engine 150 can generate segments 152 that each include one or more sentence fragments 112. The boundaries of the segments 152 can be defined by one or more of the split positions 142.

As an example, the system 100 can obtain a sequence of text 102. The system 100 can use the tokenizer engine 110 to divide the sequence of text 102 into multiple sentence fragments 112. The system can use the embedding model 120 to embed each of the sentence fragments 112. The system can use the scoring engine 130 to determine a split score for each pair of sentence fragments in sentence fragments 112 by processing the corresponding embedded sentence fragments of embedded sentence fragments 122. The system 100 can use the assignment engine 140 to assign split positions based on the split scores 132. The system 100 can provide the split positions 142 and the sentence fragments 112 to the segment combination engine 150 to generate the segments 152. The system 100 can output the segments 152.

In some implementations, the system 100 can include a user interface. The user interface can be configured to allow a user to interact with the system 100. For example, the user interface can allow a user to input a sequence of text 102 and receive data representing one or more of the segments 152 from the system 100.

In some implementations, the system 100 can include one or more language models. For example, the system 100 can provide the segments 152 to the one or more language models to process the segments 152. For example, the system can use a large language model to generate summaries of each of the segments 152. The system can perform further processing, such as classifying each segment based on the corresponding summary, and generating documents using the classified segments.

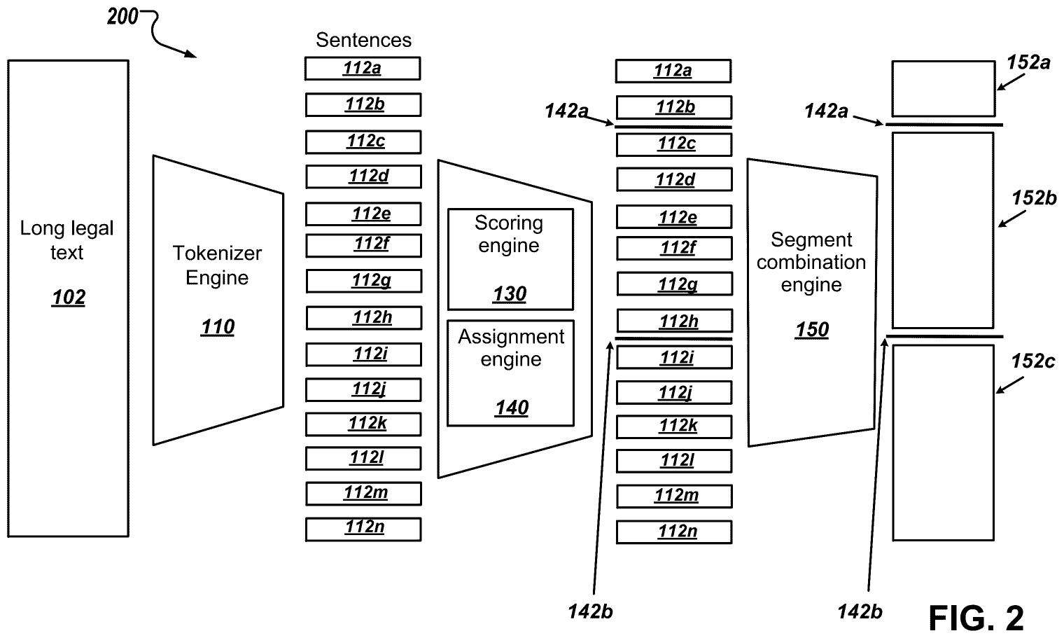

FIG. 2 is a flow diagram of an example process 200 for determining segments of text. The process 200 can be performed by a system such as the system 100, for example.

The system provides a sequence of text 102 as input to the tokenizer engine 110. In the example of FIG. 2, the sequence of text 102 is a long legal text. For example, the long legal text can include a court transcript or written opinion of more than 5 pages, more than 10 pages, more than 20 pages, or more than 50 pages of text (e.g., double-spaced text).

The tokenizer engine 110 can process the sequence of text 102 to generate sentence fragments 112. In some examples, a sentence fragment can include a full sentence. In some examples, the sentence fragment can include part of a sentence. In the example of FIG. 2, the sentence fragments include sentence fragments 112a-n.

The system processes the sentence fragments 112 to determine split positions 142. The system can use the scoring engine 130 and the assignment engine 140 to determine the split positions 142. For example, the scoring engine 130 can process embedded sentence fragments of the sentence fragments 112 to determine a split score for each pair of sentence fragments. For example, the scoring engine 130 can determine a split score for sentence fragments 112a and 112b, and a split score for sentence fragments 112b and 112c, etc. The assignment engine 140 can assign split positions based on the split scores. In the example of FIG. 2, there are two split positions, 142a and 142b, for the sentence fragments 112. For example, the split score for sentence fragments 112b and 112c, and the split score for sentence fragments 112h and 112i, can be the highest split scores.

The system provides the split positions 142 to the segment combination engine 150. The segmentation combination engine 150 generates segments 152. In the example of FIG. 2, the segment combination engine 150 outputs three segments 152a-c. Each segment includes one or more sentence fragments. The boundary of each segment is defined by the split positions. For example, segment 152a can include sentence fragments 112a-b, with the ending boundary identified by the split position 142a. Segment 152b can include sentence fragments 112c-h, with the starting boundary identified by the split position 142a and the ending boundary identified by the split position 142b. Segment 152c can include sentence fragments 112i-n, with the starting boundary identified by the split position 142b.

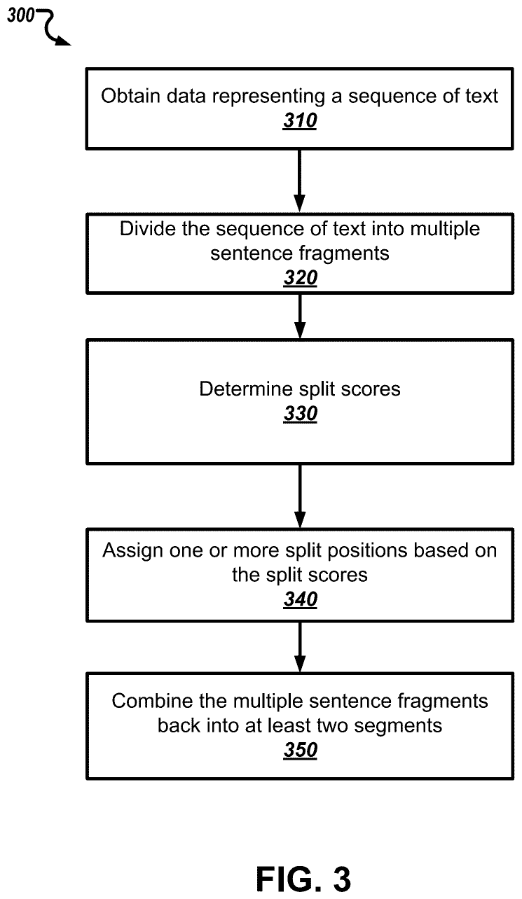

FIG. 3 is a flow chart of an example process 300 for determining segments of text. For convenience, the process 300 will be described as being performed by a system of one or more computers located in one or more locations. For example, a system for determining segments of text, e.g., the system 100 of FIG. 1, appropriately programmed in accordance with this specification, can perform the process 300.

The system obtains data representing a sequence of text (310). For example, the sequence of text can represent one or more legal documents. In some implementations, the system can obtain data representing a sequence of text by receiving the data from a user. For example, the system can receive the data as part of a query from the user about the sequence of text.

The system divides the sequence of text into multiple sentence fragments (320). For example, the system can provide the sequence of text as input to a model that is configured to generate multiple sentence fragments given an input sequence of text. The model can be the tokenizer engine 110 described above with reference to FIG. 1, for example.

The system determines split scores (330). For example, the system can determine a split score for each of multiple pairs of sentence fragments formed from the multiple sentence fragments. Each of the pairs of sentence fragments can include two consecutive sentence fragments from the multiple sentence fragments. Each split score can correspond to a pair of consecutive sentence fragments and can represent a likelihood that the pair of sentence fragments belong to different segments.

In some implementations, the system can determine split scores using similarity scores. A high similarity score between two sentence fragments can indicate a lower measure of similarity, that is, a lower likelihood that the two sentence fragments are related, or that the two sentence fragments are about the same topic. Determining split scores using similarity scores is described in further detail below with reference to FIG. 4.

In some implementations, the system can determine a split score for each of the multiple pairs of sentence fragments by using a language model. The language model can generate an output that identifies whether the two sentence fragments in each pair of sentence fragments are similar. For example, for each pair of sentence fragments, the system can use the language model to generate a prediction or a likelihood that the two sentence fragments belong to the same segment.

As another example, for each pair of sentence fragments, the system can obtain multiple predictions from the language model for whether the two sentence fragments belong to the same segment. The system can determine the split score for a pair of sentence fragments based on the predictions obtained from the language model. For example, the system can provide the pair of sentence fragments as input to the language model ten times, and receive ten predictions. The system can use the number of predictions that indicate the two sentence fragments do not belong to the same segment, divided by ten, as the split score for the pair of sentence fragments.

The system assigns one or more split positions based on the split scores (340). The split positions can reflect a lowest similarity between two sentence fragments in a pair of sentence fragments, among all pairs of sentence fragments. In some implementations, the split positions that reflect the lowest similarity can have the highest split scores among the pairs of sentence fragments. In some implementations, the system can assign the top n highest split scores as split positions, where n is an integer greater than or equal to one. In some implementations, the system can assign split positions corresponding to split scores over a threshold split score.

In some implementations, the system assigns one or more split positions iteratively, for example, in a constrained greedy process. Assigning split positions based on the split scores is described in further detail below with reference to FIG. 5.

The system combines the multiple sentence fragments back into at least two segments (350). Each segment can include one or more sentence fragments. Each segment can be defined by two boundaries, for example, a starting and an ending boundary. The boundaries for a segment can indicate which sentence fragments belong to the segment. For at least one of the at least two segments, at least one of the boundaries can be identified by one of the split positions. In some examples, the starting boundary is defined by the start of the sequence of text. In some examples, the ending boundary is defined by the end of the sequence of text. For example, referring to FIG. 2, the starting boundary for segment 152a is the start of the sequence of text, and the ending boundary is identified by split position 142a. The starting boundary for segment 152b is identified by split position 142a, and the ending boundary is identified by split position 142b. The starting boundary for segment 152c is identified by split position 142b, and the ending boundary is identified by the end of the sequence of text.

In some implementations, the system can further provide the at least two segments to a user. For example, the system can provide data representing the segments to the user through a user interface. In other implementations, the system can further provide a single segment to the user, e.g., in response to a search query.

In some implementations, the system can generate a mapping of an identifier for each of the segments to a corresponding location of the segment within the sequence of text. For example, the system can generate an identifier for each of the segments. The identifier can be a number, a title, or a summary for the segment. The system can generate the title or the summary by providing the text of the segment to a large language model, for example. The system can obtain a corresponding location for each of the segments. For example, the system can identify a page number and/or line number in the sequence of text that the segment begins on as the corresponding location. The system can thus generate a mapping that lists the identifier for each segment and the corresponding location.

In some implementations, the system can generate a summary for each of the segments. For example, for each segment, the system can provide the text of the segment to a large language model and receive a natural language summary of the content of the segment. The system can provide data representing the summary(ies) to a user.

In some implementations, the system can receive a query from a user regarding the sequence of text. The system can identify relevant segments to the query and provide the identified relevant segment(s) to the user. For example, the sequence of text may represent a contract, and the query may include a request to find indemnity clauses located in the contract. The system can process the contract to determine segments. The system can process the segments using a language model to obtain a topic or summary for each of the segments. The system can identify relevant segments to the query using the summaries for the segments. For example, the system can identify segments that include indemnity clauses using the summaries for the segments. The system can provide data representing the identified relevant segment(s) to the user.

The system can identify segments that include indemnity clauses by identifying segments that are likely to include indemnity clauses. For example, the system can process a prompt for each segment that includes the segment and a request to identify whether the segment is likely to include an indemnity clause using a language model to obtain an output identifying whether the segment is likely to include an indemnity clause. In some examples, the prompt can also include examples of indemnities or a description of indemnities. As another example, the system can process the prompt for each segment multiple times using the language model to obtain multiple outputs. The system can determine whether a segment is likely to include an indemnity clause by combining the outputs for the segment. For example, the system can determine that a segment is likely to include an indemnity clause if a majority of the outputs indicate that the segment is likely to include an indemnity clause.

As another example, the system can process a prompt for each segment that includes the segment and a request to determine the likelihood that the segment includes an indemnity clause using a language model to obtain an output identifying a likelihood that the segment includes an indemnity clause. In some examples, the prompt can also include examples of indemnities or a description of indemnities. The system can determine that a segment is likely to include an indemnity clause if the output indicates that the likelihood is greater than 50%. As another example, the system can process the prompt for each segment multiple times using the language model to obtain multiple outputs. The system can determine whether a segment is likely to include an indemnity clause by combining, e.g., averaging, the outputs for the segment. For example, the system can determine that a segment is likely to include an indemnity clause if the average of the outputs indicates that the likelihood is greater than 50%.

As another example, the system can provide the segment to a machine learning model that has been trained to generate a likelihood of indemnity score. The system can determine that a segment is likely to include an indemnity clause if the indemnity score meets a threshold indemnity score. In some examples, the threshold indemnity score can be predetermined. In some examples, the threshold indemnity score can be obtained from a user.

In some implementations, the query may include a request to generate a new sequence of text. For example, the user can provide a sequence of text that includes a large number of contracts previously written by the user. The query may include a request to generate a new indemnity clause that includes any previously written indemnity clause written by the user. The system can identify segments that include indemnity clauses as described above. The system can generate a new indemnity clause by combining the identified segments, for example, using a language model. For example, the system can provide a prompt that includes at least the identified segments and a request to generate a new indemnity clause based on the identified segments as input to the language model. The system can provide data representing the new indemnity clause to the user.

FIG. 4 is a flow chart of an example process 400 for determining split scores. The process 400 can be performed as part of step 330 described above with reference to FIG. 3. The process 400 can be performed by a system such as the scoring engine 130 described above with reference to FIG. 1.

The system generates a corresponding embedded sentence fragment for each of the sentence fragments (410). For example, the system can provide each sentence fragment to an embedding model that is configured to generate an embedding of a given sentence fragment. For example, the embedding model can be the embedding model 120 of FIG. 1.

For each pair of sentence fragments, the system determines a first similarity score (420). The first similarity score can represent a measure of similarity between the sentence fragments in the pair of sentence fragments. For example, referring to FIG. 2, if the pair of sentence fragments includes sentence fragment 112d and sentence fragment 112e, the first similarity score can represent a measure of similarity between sentence fragment 112d and sentence fragment 112c.

For each pair of sentence fragments, the system determines one or more second similarity scores (430). Each of the second similarity scores can represent a measure of similarity between two sentence fragments in the multiple sentence fragments. For example, one of the second similarity scores can represent a measure of similarity between the first sentence fragment in the pair of sentence fragments, and the sentence fragment following the second sentence fragment in the pair of sentence fragments. For example, referring to FIG. 2, the second similarity score can represent a measure of similarity between sentence fragment 112d and sentence fragment 112f. As another example, another of the second similarity scores can represent a measure of similarity between the second sentence fragment in the pair of sentence fragments, and the sentence fragment preceding the first sentence fragment in the pair of sentence fragments. For example, referring to FIG. 2, the second similarity score can represent a measure of similarity between sentence fragment 112c and sentence fragment 112c.

The system determines the split score for the pair of sentence fragments by combining the first similarity score and the one or more second similarity scores (440). For example, the system can determine the split score for the pair of sentence fragments 112d and 112e by combining the similarity score for sentence fragments 112d and 112e, sentence fragments 112d and 112f, and sentence fragments 112c and 112e. For example, the system can compute a weighted sum of the first similarity score and the one or more second similarity scores. For example, the first similarity score can be weighted by a factor of 0.5, and each of the second similarity scores can be weighted by a factor of 0.25.

In these implementations, the system can determine each of the first similarity scores and the second similarity scores by computing a similarity between the corresponding embedded sentence fragments. The similarity can represent a similarity in vector space of the corresponding embedded sentence fragments. Some examples of computing a similarity include cosine similarity, or other functions that receive two vectors and determine a score for the two vectors. As an example, the system can determine similarity scores based on the distance in vector space between the embedded sentence fragments. For example, the system can determine the first similarity score by computing the distance between the corresponding embedded sentence fragments for the two sentence fragments of the pair of sentence fragments. The system can determine each of the one or more second similarity scores by computing the distance between the corresponding embedded sentence fragment for one of the two sentence fragments of the pair of sentence fragments, and a corresponding sentence fragment for another sentence fragment of the multiple sentence fragments.

As another example, the system can determine similarity scores using a machine learning model that is configured to generate a similarity score between vectors. For example, the system can provide the embedded sentence fragments to the machine learning model. For example, the system can determine the first similarity score by providing the corresponding embedded sentence fragments for the two sentence fragments of the pair of sentence fragments to the machine learning model. The system can determine each of the one or more second similarity scores by providing the corresponding embedded sentence fragment for one of the two sentence fragments of the pair of sentence fragments, and a corresponding sentence fragment for another sentence fragment of the multiple sentence fragments, to the machine learning model.

FIG. 5 is a flow chart of an example process 500 for assigning split positions. The process 500 can be performed as part of step 340 described above with reference to FIG. 3. The process 500 can be performed by a system such as the assignment engine 140 described above with reference to FIG. 1.

The system assigns the one or more split positions based on a current set of split scores at each of multiple iterations. At the first iteration, the current set of split scores can include the split scores determined in step 330 of FIG. 3.

At each iteration, the system determines whether a termination condition has been met. The termination condition can be defined by a condition where all of the split scores in the current set of split scores are zero. In some implementations, the termination condition can be defined by a condition where all of the split scores in the current set of split scores are less than a threshold split score. In some implementations, the termination condition can be defined by a threshold number of iterations. In some implementations, the termination condition can be defined by a threshold runtime or amount of computing resources consumed.

If the termination condition has not been met (504), the system assigns a split position (510). For example, the system can assign a split position corresponding to an index for the pair of sentence fragments with a highest split score in the current set of split scores. Referring to FIG. 2 as an example, the system can assign split position 142b that corresponds to the pair of sentence fragments 112h and 112i.

The system modifies the split scores (520). For example, the system modifies the current set of split scores by setting the highest split score to zero. Because the index corresponding to the highest split score has already been assigned as a split position, the highest split score in the current set of split scores can be set to zero.

The system identifies a first set of sentence fragments (530). The first set of sentence fragments can include one or more sentence fragments that precede the split position and have split scores in the current set of split scores. For example, referring to FIG. 2, the first set of sentence fragments can include sentence fragments 112a-h.

The system identifies a second set of sentence fragments (540). The second set of sentence fragments can include one or more sentence fragments that follow the split position and have split scores in the current set of split scores. For example, referring to FIG. 2, the second set of sentence fragments can include sentence fragments 112i-n.

For each set of the first and second set, the system identifies a respective subset of sentence fragments (550). The respective subset for the first set and the second set can define a radius of pairs of sentence fragments around the split position for which the system should not assign another split. For example, assigning a split position within the radius would result in producing a segment that is too short, or less than a threshold of tokens. For example, the tokens can include characters, subwords, or words. The threshold of tokens can be, for example, at least 10 tokens, at least 20 tokens, at least 40 tokens, at least 80 tokens, or at least 160 tokens.

As an example, the respective subset can include a cumulative number of tokens greater than or equal to a threshold number of tokens. The respective subset can include one or more sentence fragments, each including a number of tokens that add up to the cumulative number of tokens. In some implementations, the respective subset can include the smallest number of sentence fragments that include a cumulative number of tokens greater than or equal to the threshold number of tokens. Referring to FIG. 2, the system can identify a subset for the first set that includes sentence fragments 112f-h. For example, sentence fragments 112h and 112g together may have less than the threshold number of tokens, but sentence fragments 112h, 112g, and 112f together may have a sufficient number of tokens. The system can identify a subset for the second set that includes sentence fragments 112i-j. For example, sentence fragment 112i may have less than the threshold number of tokens, but sentence fragments 112i and 112j together may have a sufficient number of tokens.

For each set of the first and second set, the system modifies the split scores (560). The system can modify the current set of split scores by setting the split scores corresponding to the pairs of sentence fragments in the respective subset to zero. For example, the system can set the split scores for the pairs of sentence fragments in the subset for the first set, and the subset for the second set, to zero. Referring to FIG. 2, the system can set the split scores for sentence fragments 112g-h and 112f-g, and the split scores for 112i-j, to zero. The system will thus not assign split positions for pairs of sentence fragments within the radius.

For each set of the first and second set, the system updates the split scores (570). The system can update the current set of split scores to the split scores for the sentence fragments of the set. That is, the system updates the current set of split scores to include the split scores for the sentence fragments of the first set. The system thus processes the first set (sentence fragments preceding the split position) to assign further split positions by returning to the start of the process 500. The system also updates the current set of split scores to include the split scores for the sentence fragments of the second set. For example, the system generates another current set of split scores. The system thus processes the second set (sentence fragments following the split position) independently from the first set to assign further split positions by returning to the start of the process 500.

The system returns to the start of the process 500 by checking the termination condition for each current set of split scores. If the termination condition is not met (504) for the current set of split scores, the system performs steps 510-570.

If the termination condition has been met for the current set of split scores, the system returns to the start of the process 500 for any other current sets of split scores that the system has not processed.

If the termination condition has been met for all current sets of classification scores (502), the system proceeds to step 350 of FIG. 3. The system combines the sentence fragments back into segments based on the split positions assigned in steps 504-570.

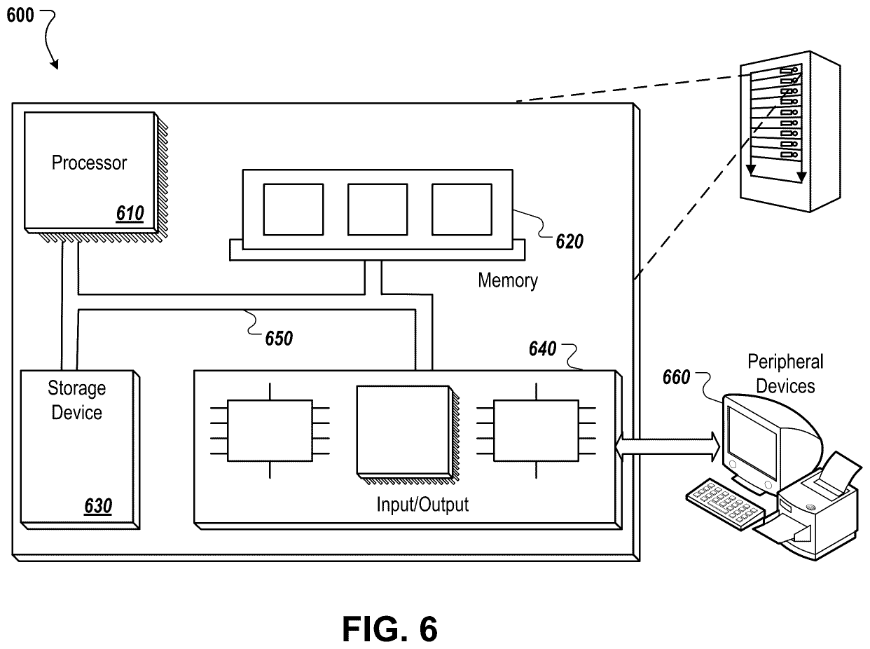

FIG. 6 depicts a schematic diagram of a computer system 600. The system 600 can be used to carry out the operations described in association with any of the computer-implemented methods described previously, according to some implementations. In some implementations, computing systems and devices and the functional operations described in this specification can be implemented in digital electronic circuitry, in tangibly-embodied computer software or firmware, in computer hardware, including the structures disclosed in this specification (e.g., system 600) and their structural equivalents, or in combinations of one or more of them. The system 600 is intended to include various forms of digital computers, such as laptops, desktops, workstations, personal digital assistants, servers, blade servers, mainframes, and other appropriate computers, including vehicles installed on base units or pod units of modular vehicles. The system 600 can also include mobile devices, such as personal digital assistants, cellular telephones, smartphones, and other similar computing devices. Additionally, the system can include portable storage media, such as, Universal Serial Bus (USB) flash drives. For example, the USB flash drives may store operating systems and other applications. The USB flash drives can include input/output components, such as a wireless transducer or USB connector that may be inserted into a USB port of another computing device.

The system 600 includes a processor 610, a memory 620, a storage device 630, and an input/output device 640. Each of the components 610, 620, 630, and 640 are interconnected using a system bus 650. The processor 610 is capable of processing instructions for execution within the system 600. The processor may be designed using any of a number of architectures. For example, the processor 610 may be a CISC (Complex Instruction Set Computers) processor, a RISC (Reduced Instruction Set Computer) processor, or a MISC (Minimal Instruction Set Computer) processor.

In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output device 640.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 may be a floppy disk device, a hard disk device, an optical disk device, or a tape device.

The input/output device 640 provides input/output operations for the system 600. In one implementation, the input/output device 640 includes a keyboard and/or pointing device. In another implementation, the input/output device 640 includes a display unit for displaying graphical user interfaces.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a key vectorboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method comprising:
obtaining data representing a sequence of text;
dividing the sequence of text into a plurality of sentence fragments;
determining split scores comprising determining a split score for each of a plurality of pairs of sentence fragments formed from the plurality of sentence fragments;
assigning one or more split positions based on the split scores; and
combining the plurality of sentence fragments back into at least two segments, with a boundary of at least one of the at least two segments being identified by one of the one or more split positions, and wherein each segment comprises one or more sentence fragments.

Embodiment 2 is the method of embodiment 1, wherein the sequence of text represents one or more legal documents.

Embodiment 3 is the method of any of embodiments 1-2, wherein obtaining data representing a sequence of text comprises receiving the data from a user.

Embodiment 4 is the method of any of embodiments 1-3, further comprising providing the at least two segments to a user.

Embodiment 5 is the method of any of embodiments 1-4, further comprising:
receiving a query from a user;
identifying one or more relevant segments to the query from the at least two segments; and
providing the one or more identified relevant segments to the user.

Embodiment 6 is the method of any of embodiments 1-5, wherein dividing the text into a plurality of sentence fragments comprises providing the sequence of text as input to a model that is configured to generate a plurality of sentence fragments given an input sequence of text.

Embodiment 7 is the method of any of embodiments 1-6, wherein determining a split score for each of a plurality of pairs of sentence fragments comprises:
generating a corresponding embedded sentence fragment for each of the plurality of sentence fragments;
for each pair of sentence fragments:
   determining a first similarity score between two sentence fragments in the pair of sentence fragments;
   determining one or more second similarity scores, wherein each second similarity score is determined between two sentence fragments in the plurality of sentence fragments; and
   determining the split score for the pair of sentence fragments by combining the first similarity score and the one or more second similarity scores.

Embodiment 8 is the method of embodiment 7, wherein determining a first similarity score comprises computing a similarity between the corresponding embedded sentence fragments for the two sentence fragments.

Embodiment 9 is the method of any of embodiments 7-8, wherein determining one or more second similarity scores comprises, for each of the one or more second similarity scores: computing a similarity between a first embedded sentence fragment and a second embedded sentence fragment, wherein the first embedded sentence fragment comprises the corresponding embedded sentence fragment for a first particular sentence fragment of the two sentence fragments, and wherein the second embedded sentence fragment comprises the corresponding embedded sentence fragment for a second particular sentence fragment of the plurality of sentence fragments.

Embodiment 10 is the method of any of embodiments 7-9, wherein determining a first similarity score comprises providing the corresponding embedded sentence fragments for the two sentence fragments to a machine learning model that is configured to generate a similarity score between vectors.

Embodiment 11 is the method of any of embodiments 7-10, wherein determining one or more second similarity scores comprises, for each of the one or more second similarity scores: providing a first embedded sentence fragment and a second embedded sentence fragment to a machine learning model that is configured to generate a similarity score between vectors, wherein the first embedded sentence fragment comprises the corresponding embedded sentence fragment for a first particular sentence fragment of the two sentence fragments, and wherein the second embedded sentence fragment comprises the corresponding embedded sentence fragment for a second particular sentence fragment of the plurality of sentence fragments.

Embodiment 12 is the method of any of embodiments 7-11, wherein combining the first similarity score and the one or more second similarity scores comprises computing a weighted sum of the first similarity score and the one or more second similarity scores.

Embodiment 13 is the method of any of embodiments 1-12, wherein determining a split score for each of a plurality of pairs of sentence fragments comprises using a language model to identify whether two sentence fragments are similar in the pair of sentence fragments.

Embodiment 14 is the method of any of embodiments 1-13, wherein assigning one or more split positions based on the split scores comprises determining one or more split positions that each reflect a lowest similarity between two sentence fragments in a particular pair of sentence fragments among the plurality of pairs of sentence fragments.

Embodiment 15 is the method of embodiment 14, wherein the one or more split positions that each reflect a lowest similarity between two sentence fragments have a highest split score among the plurality of pairs of sentence fragments.

Embodiment 16 is the method of any of embodiments 1-15, wherein assigning one or more split positions based on the split scores comprises assigning one or more split positions based on a current set of split scores at each of a plurality of iterations, and wherein the method comprises, at each iteration:
determining that a termination condition has not been met;
in response to determining that the termination condition has not been met, assigning a split position corresponding to an index for a pair of sentence fragments with a highest split score in the current set of split scores;
modifying the current set of split scores by setting the highest split score to zero;
identifying a first set of sentence fragments comprising one or more sentence fragments of the plurality of sentence fragments preceding the split position;
identifying a second set of sentence fragments comprising one or more sentence fragments of the plurality of sentence fragments following the split position;
for each set of the first set and second set:
   identifying a respective subset of sentence fragments in the set;
   modifying the current set of split scores by setting one or more of the split scores for the pairs of sentence fragments in the respective subset to zero; and
   updating the current set of split scores to the split scores for the sentence fragments of the set.

Embodiment 17 is the method of embodiment 16, wherein the respective subset of sentence fragments comprises a cumulative number of tokens greater than or equal to a threshold number of tokens.

Embodiment 18 is the method of any of embodiments 16-17, wherein the termination condition is defined by a condition where all of the split scores are zero.

Embodiment 19 is a system comprising:
one or more computers; and
one or more storage devices storing instructions that, when executed by the one or more computers, cause the one or more computers to perform the method of any of embodiments 1-18.

Embodiment 20 is one or more computer-readable storage media storing instructions that when executed by one or more computers cause the one or more computers to perform the method of any of embodiments 1-18.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
obtaining data representing a sequence of text;
dividing the sequence of text into a plurality of sentence fragments;
determining split scores comprising determining a split score for each of a plurality of pairs of sentence fragments formed from the plurality of sentence fragments;
assigning one or more split positions based on the split scores; and
combining the plurality of sentence fragments back into at least two segments, with a boundary of at least one of the at least two segments being identified by one of the one or more split positions, and wherein each segment comprises one or more sentence fragments.

2. The method of claim 1, wherein the sequence of text represents one or more legal documents.

3. The method of claim 1, wherein obtaining data representing a sequence of text comprises receiving the data from a user.

4. The method of claim 1, further comprising providing the at least two segments to a user.

5. The method of claim 1, further comprising:
receiving a query from a user;
identifying one or more relevant segments to the query from the at least two segments; and
providing the one or more identified relevant segments to the user.

6. The method of claim 1, wherein dividing the text into a plurality of sentence fragments comprises providing the sequence of text as input to a model that is configured to generate a plurality of sentence fragments given an input sequence of text.

7. The method of claim 1, wherein determining a split score for each of a plurality of pairs of sentence fragments comprises:
generating a corresponding embedded sentence fragment for each of the plurality of sentence fragments;
for each pair of sentence fragments:
determining a first similarity score between two sentence fragments in the pair of sentence fragments;
determining one or more second similarity scores, wherein each second similarity score is determined between two sentence fragments in the plurality of sentence fragments; and
determining the split score for the pair of sentence fragments by combining the first similarity score and the one or more second similarity scores.

8. The method of claim 7, wherein determining a first similarity score comprises computing a similarity between the corresponding embedded sentence fragments for the two sentence fragments.

9. The method of claim 7, wherein determining one or more second similarity scores comprises, for each of the one or more second similarity scores: computing a similarity between a first embedded sentence fragment and a second embedded sentence fragment, wherein the first embedded sentence fragment comprises the corresponding embedded sentence fragment for a first particular sentence fragment of the two sentence fragments, and wherein the second embedded sentence fragment comprises the corresponding embedded sentence fragment for a second particular sentence fragment of the plurality of sentence fragments.

10. The method of claim 7, wherein determining a first similarity score comprises providing the corresponding embedded sentence fragments for the two sentence fragments to a machine learning model that is configured to generate a similarity score between vectors.

11. The method of claim 7, wherein determining one or more second similarity scores comprises, for each of the one or more second similarity scores: providing a first embedded sentence fragment and a second embedded sentence fragment to a machine learning model that is configured to generate a similarity score between vectors, wherein the first embedded sentence fragment comprises the corresponding embedded sentence fragment for a first particular sentence fragment of the two sentence fragments, and wherein the second embedded sentence fragment comprises the corresponding embedded sentence fragment for a second particular sentence fragment of the plurality of sentence fragments.

12. The method of claim 7, wherein combining the first similarity score and the one or more second similarity scores comprises computing a weighted sum of the first similarity score and the one or more second similarity scores.

13. The method of claim 1, wherein determining a split score for each of a plurality of pairs of sentence fragments comprises using a language model to identify whether two sentence fragments are similar in the pair of sentence fragments.

14. The method of claim 1, wherein assigning one or more split positions based on the split scores comprises determining one or more split positions that each reflect a lowest similarity between two sentence fragments in a particular pair of sentence fragments among the plurality of pairs of sentence fragments.

15. The method of claim 14, wherein the one or more split positions that each reflect a lowest similarity between two sentence fragments have a highest split score among the plurality of pairs of sentence fragments.

16. The method of claim 1, wherein assigning one or more split positions based on the split scores comprises assigning one or more split positions based on a current set of split scores at each of a plurality of iterations, and wherein the method comprises, at each iteration:
determining that a termination condition has not been met;
in response to determining that the termination condition has not been met, assigning a split position corresponding to an index for a pair of sentence fragments with a highest split score in the current set of split scores;
modifying the current set of split scores by setting the highest split score to zero;
identifying a first set of sentence fragments comprising one or more sentence fragments of the plurality of sentence fragments preceding the split position;
identifying a second set of sentence fragments comprising one or more sentence fragments of the plurality of sentence fragments following the split position;
for each set of the first set and second set:
identifying a respective subset of sentence fragments in the set;
modifying the current set of split scores by setting one or more of the split scores for the pairs of sentence fragments in the respective subset to zero; and
updating the current set of split scores to the split scores for the sentence fragments of the set.

17. The method of claim 16, wherein the respective subset of sentence fragments comprises a cumulative number of tokens greater than or equal to a threshold number of tokens.

18. The method of claim 16, wherein the termination condition is defined by a condition where all of the split scores are zero.

19. A system comprising:
one or more computers; and
one or more storage devices storing instructions that, when executed by the one or more computers, cause the one or more computers to perform operations comprising:
obtaining data representing a sequence of text;
dividing the sequence of text into a plurality of sentence fragments;
determining split scores comprising determining a split score for each of a plurality of pairs of sentence fragments formed from the plurality of sentence fragments;
assigning one or more split positions based on the split scores; and
combining the plurality of sentence fragments back into at least two segments, with a boundary of at least one of the at least two segments being identified by one of the one or more split positions, and wherein each segment comprises one or more sentence fragments.

20. One or more computer-readable storage media storing instructions that when executed by one or more computers cause the one or more computers to perform operations comprising:
obtaining data representing a sequence of text;
dividing the sequence of text into a plurality of sentence fragments;
determining split scores comprising determining a split score for each of a plurality of pairs of sentence fragments formed from the plurality of sentence fragments;
assigning one or more split positions based on the split scores; and
combining the plurality of sentence fragments back into at least two segments, with a boundary of at least one of the at least two segments being identified by one of the one or more split positions, and wherein each segment comprises one or more sentence fragments.
